(19) United States
(12) Patent Application Publication
(10) Pub. No.: US 2018/0344551 A1
(43) Pub. Date: Dec. 6, 2018

(54) Motorized Bed with Improved Lifting Device

(71) Applicant: APEX HEALTH CARE MFG. INC., Minxiong Township (TW)

(72) Inventor: Chi-Chung Huang, Minxiong Township (TW)

(21) Appl. No.: 15/610,669

(22) Filed: Jun. 1, 2017

(51) Int. Cl. A61G 7/012; A61G 7/018; A47C 19/04

(52) U.S. Cl. CPC A61G 7/012; A47C 19/045; A61G 7/018

(57) ABSTRACT

A motorized bed includes a bottom bracket, a frame and a lifting device. The lifting device includes two drive mechanisms, two linkages and two connecting units. Each of the drive mechanisms includes a retractable push member. Each of the linkages includes a first link pivotally connected with the frame and the push member of one of the drive mechanisms and two second links pivotally connected with the first link. Each of the connecting units includes a transverse lever and two locking levers. Each of the locking levers of each of the connecting units has a first end pivotally connected with the transverse lever, a mediate portion pivotally connected with one of the second links of one of the linkages and a second end pivotally connected with the bottom bracket.

### BACKGROUND OF THE INVENTION

### 1. Field of the Invention

The present invention relates to a bed and, more particularly, to a motorized bed for a medical or rehabilitation use.

### 2. Description of the Related Art

A conventional motorized bed 1 in accordance with the prior art shown in FIG. 1 comprises a bottom bracket 11, a frame 10, a driving device 110 and two linkages 100. The two linkages 100 are pivotally mounted between the bottom bracket 11 and the frame 10. The driving device 110 includes a push rod 1100 pivotally connected with one of the two linkages 100. In operation, when the driving device 110 is operated, the push rod 1100 of the driving device 110 is extended or retracted to move one of the two linkages 100 so that the two linkages 100 are moved to lift or lower the frame 10. However, the two linkages 100 and the driving device 110 are arranged on the middle position of the motorized bed 1, and the frame 10 does not have any support, so that the frame 10 easily sways and produces vibration during movement. In addition, when the user does not lie on the middle position of the frame 10, the force applied on the frame 10 is not distributed evenly, so that the frame 10 is easily inclined, thereby wearing the frame 10 or breaking the two linkages 100, and thereby causing danger to the user.

### BRIEF SUMMARY OF THE INVENTION

The primary objective of the present invention is to provide a motorized bed with an improved lifting device.

In accordance with the present invention, there is provided a motorized bed comprising a bottom bracket, a frame and a lifting device. The lifting device includes two drive mechanisms, two linkages and two connecting units. The two drive mechanisms are arranged on two opposite ends of the bottom bracket. Each of the two drive mechanisms includes a retractable push member. Each of the two linkages includes a first link pivotally connected with the push member of one of the two drive mechanisms and two second links pivotally connected with the first link. The first link of each of the two linkages is pivotally connected with the frame. The two connecting units are arranged on two opposite sides of the bottom bracket. Each of the two connecting units includes a transverse lever and two locking levers. Each of the two locking levers of each of the two connecting units has a first end pivotally connected with the transverse lever and a second end pivotally connected with the bottom bracket. Each of the two locking levers of each of the two connecting units has a mediate portion pivotally connected with one of the two second links of one of the two linkages.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a conventional motorized bed in accordance with the prior art.

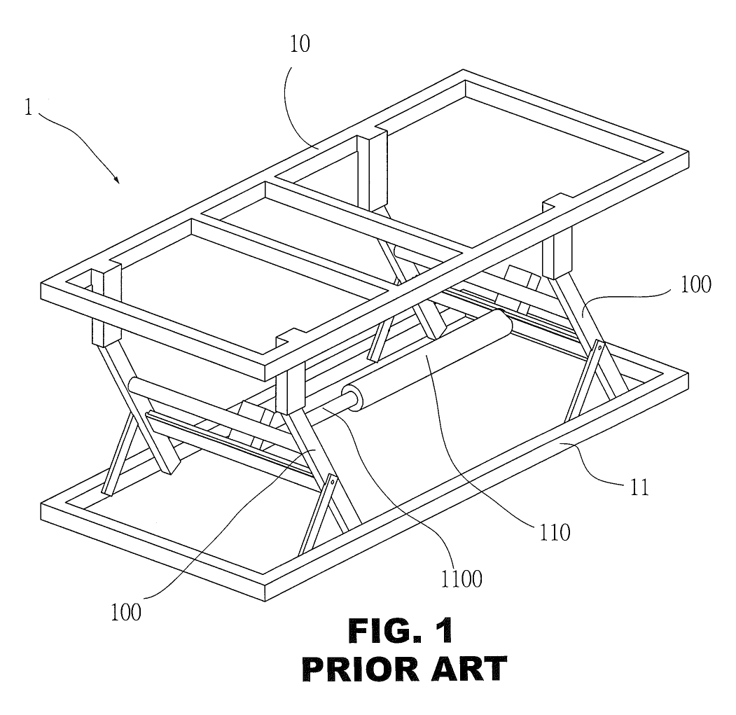

FIG. 2 is a perspective view of a motorized bed in accordance with the preferred embodiment of the present invention.

FIG. 3 is a partially exploded perspective view of the motorized bed in accordance with the preferred embodiment of the present invention.

FIG. 4 is a side view of the motorized bed as shown in FIG. 2.

FIG. 5 is a schematic operational view of the motorized bed as shown in FIG. 2 in use.

FIG. 6 is a schematic operational view of the motorized bed as shown in FIG. 4 in use.

FIG. 7 is a schematic operational view of the motorized bed as shown in FIG. 5 in use.

FIG. 8 is a schematic operational view of the motorized bed as shown in FIG. 6 in use.

### DETAILED DESCRIPTION OF THE INVENTION

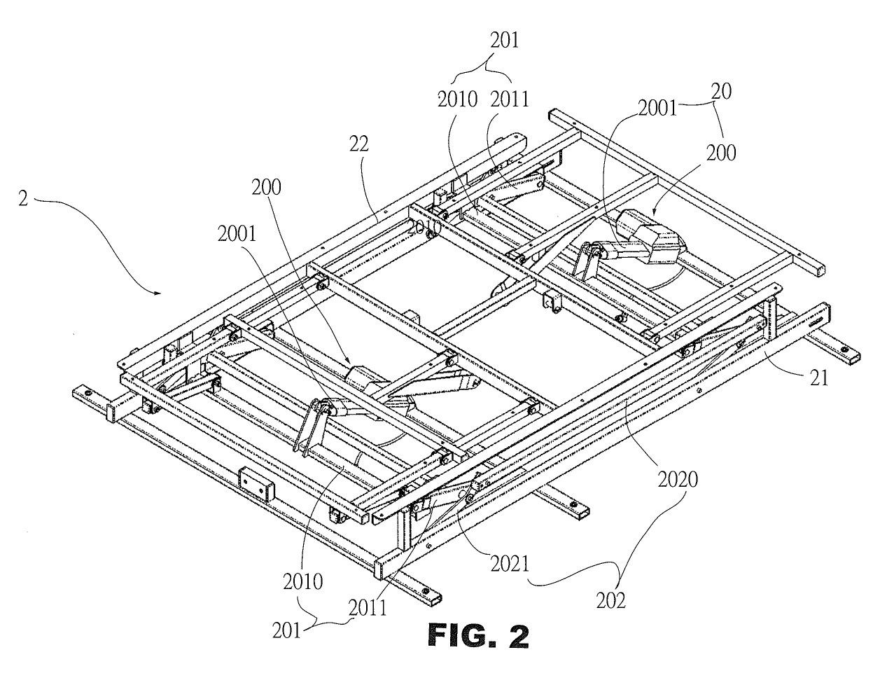

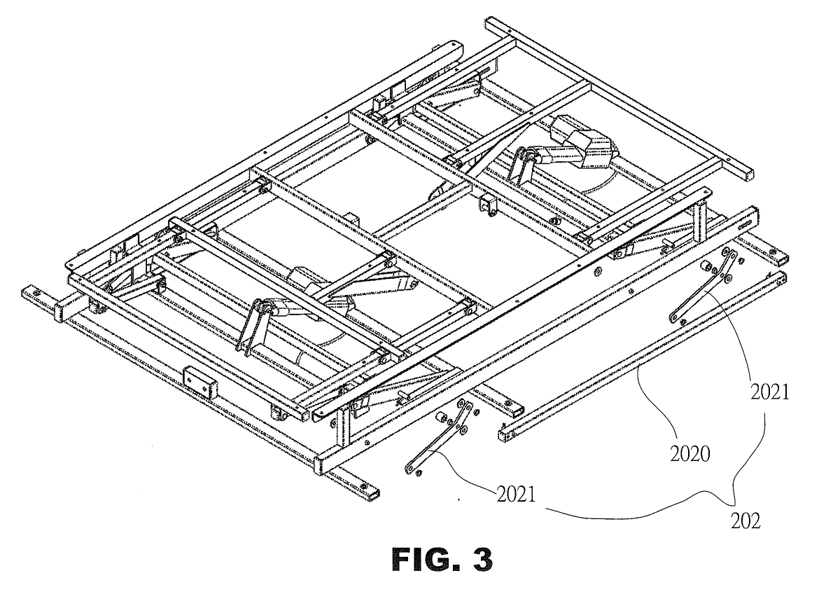

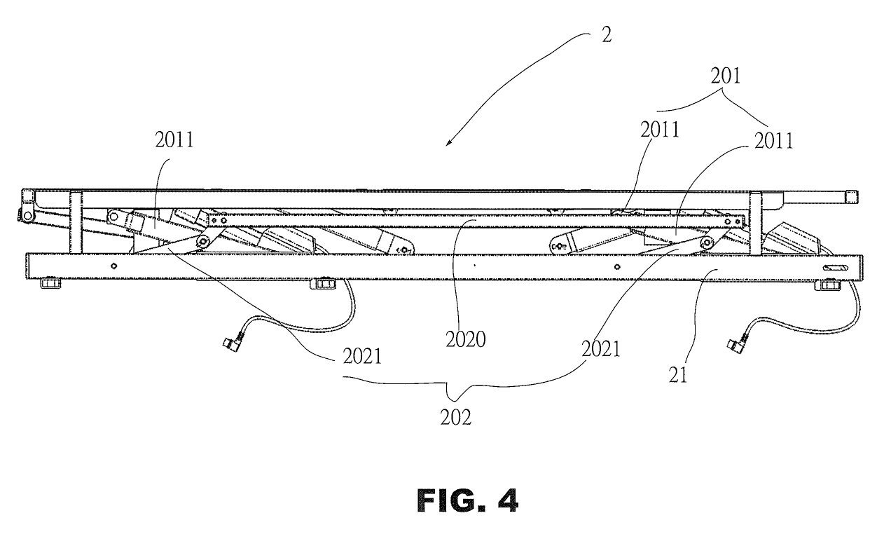

Referring to the drawings and initially to FIGS. 2-4, a motorized bed 2 in accordance with the preferred embodiment of the present invention comprises a bottom bracket 21, a frame 22 and a lifting device 20.

The lifting device 20 is mounted between the bottom bracket 21 and the frame 22 and includes two drive mechanisms 200, two linkages 201 and two connecting units 202.

The two drive mechanisms 200 are arranged on two opposite ends of the bottom bracket 21. Each of the two drive mechanisms 200 includes a retractable push member 2001.

Each of the two linkages 201 includes a first link 2010 pivotally connected with the push member 2001 of one of the two drive mechanisms 200 and two second links 2011 pivotally connected with the first link 2010. The first link 2010 of each of the two linkages 201 is pivotally connected with the frame 22. The two second links 2011 of each of the two linkages 201 are arranged on two opposite ends of the first link 2010. The two linkages 201 are driven by the two drive mechanisms 200 to push and lift the frame 22.

The two connecting units 202 are arranged on two opposite sides of the bottom bracket 21. Each of the two connecting units 202 includes a transverse lever 2020 and two locking levers 2021 mounted on two opposite ends of the transverse lever 2020. The transverse lever 2020 of each of the two connecting units 202 has an elongate shape. Each of the two locking levers 2021 of each of the two connecting units 202 is bent upward with an angle. Each of the two locking levers 2021 of each of the two connecting units 202 has a first end pivotally connected with the transverse lever 2020 and a second end pivotally connected with the bottom bracket 21. Each of the two locking levers 2021 of each of the two connecting units 202 has a bent mediate portion pivotally connected with one of the two second links 2011 of one of the two linkages 201 by screwing.

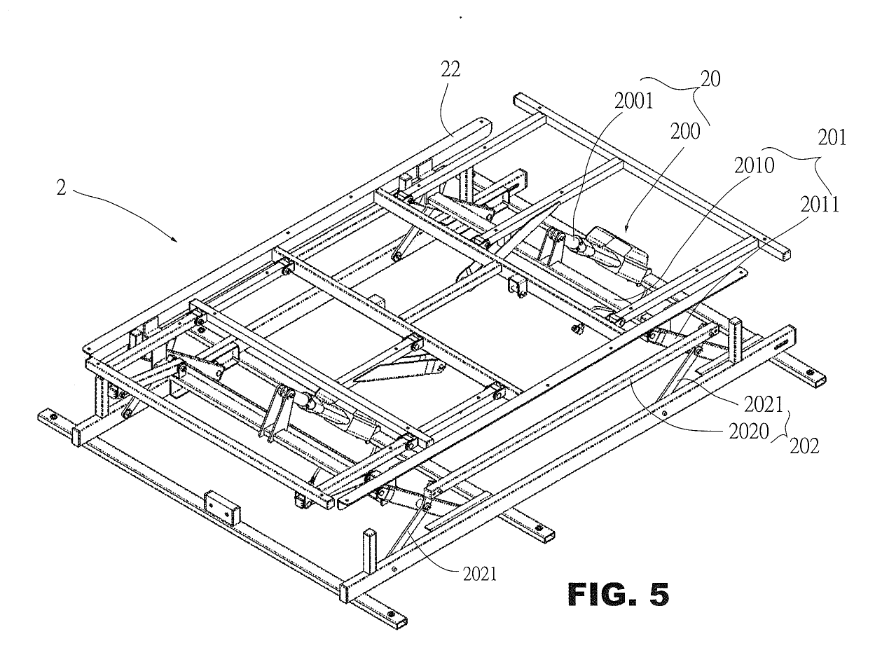

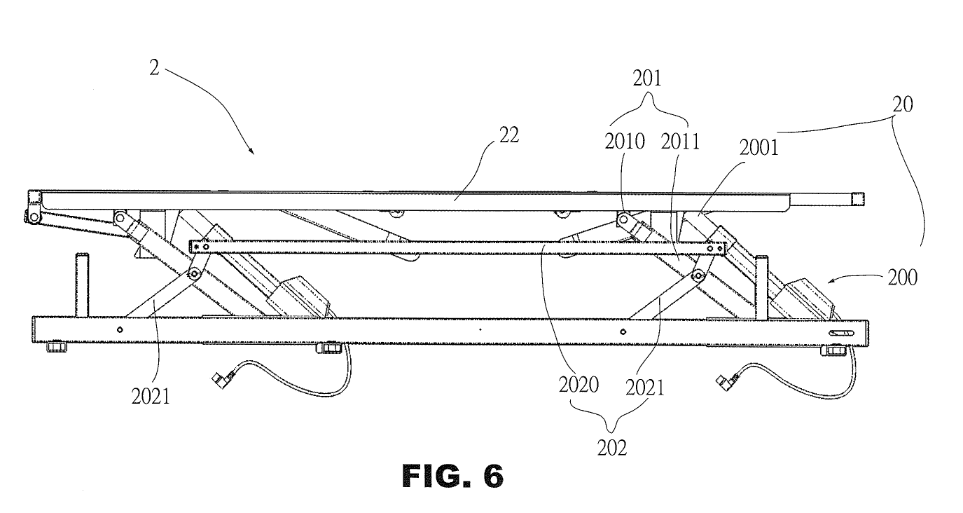

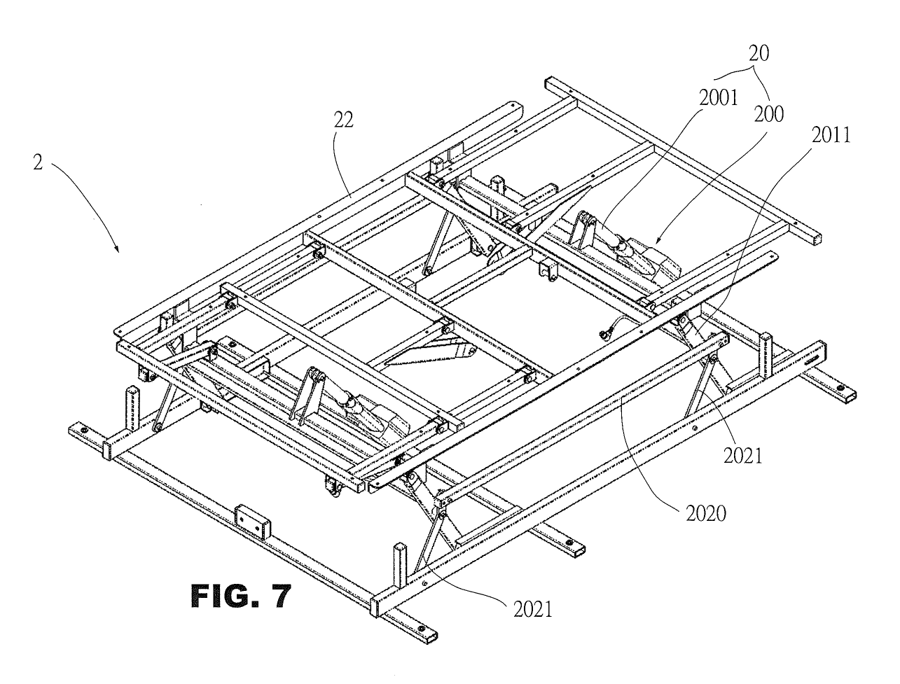

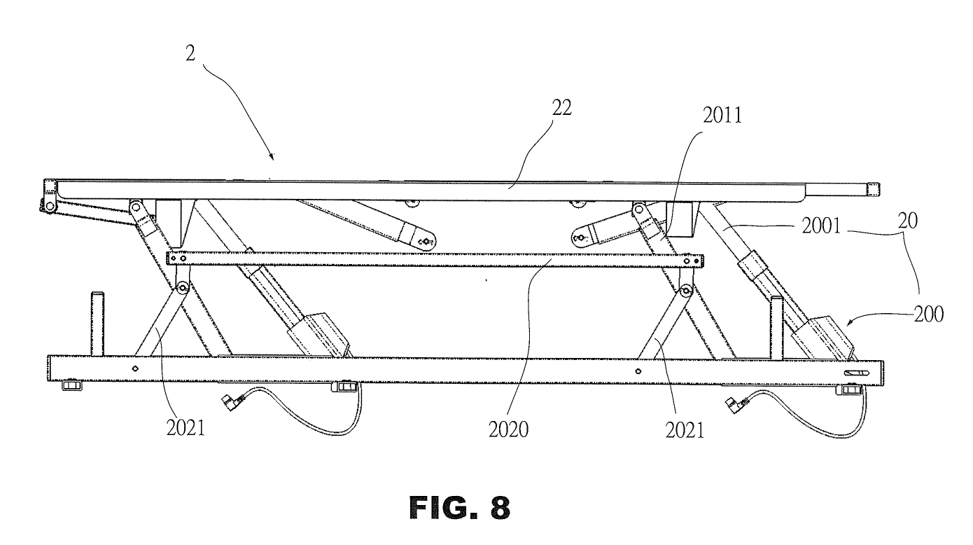

In operation, referring to FIGS. 5-8 with reference to FIGS. 2-4, when the two drive mechanisms 200 of the lifting device 20 are operated synchronously, the push member 2001 of each of the two drive mechanisms 200 is extended upward, and the first link 2010 of each of the two linkages 201 is pushed upward, so that the frame 22 is pushed upward and lifted. At the same time, the two second links 2011 of each of the two linkages 201 are driven upward by the first link 2010, and the two locking levers 2021 of each of the two connecting units 202 are driven upward by the two second links 2011 of each of the two linkages 201, so that the transverse lever 2020 of each of the two connecting units 202 is driven upward and lifted.

When the frame 22 is lifted to a determined height, the weight of the user lying on the frame 22 is transmitted downward through the two second links 2011 of each of the two linkages 201, and the two locking levers 2021 of each of the two connecting units 202 distribute the pressure to the transverse lever 2020 of each of the two connecting units 202 to reduce the pressure of each of the two linkages 201 and the push member 2001 of each of the two drive mechanisms 200. Thus, when any position of the frame 22 is subjected to a pressure, the lifting device 20 distributes the pressure to keep the stability and safety of the frame 22.

Accordingly, the two drive mechanisms 200 are arranged on the front and rear ends of the frame 22 and are operated synchronously to lift the frame 22, so that the frame 22 is moved smoothly and stably. In addition, each of the two locking levers 2021 of each of the two connecting units 202 is bent with an angle, so that when the frame 22 applies a downward pressure, each of the two locking levers 2021 of each of the two connecting units 202 distributes the pressure and transmits the pressure to the transverse lever 2020 which shares the pressure. Further, the two connecting units 202 protect the two drive mechanisms 200 and the two linkages 201 to prevent the two drive mechanisms 200 and the two linkages 201 from being worn out or broken, and to protect the user's safety.

In conclusion, the transverse lever 2020 and the two locking levers 2021 of each of the two connecting units 202 support the frame 22 and distribute the downward pressure applied by the user, so that the frame 22 is maintained smoothly and stably during lifting.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. A motorized bed comprising:
a bottom bracket, a frame and a lifting device;
wherein:
the lifting device includes two drive mechanisms, two linkages and two connecting units;
the two drive mechanisms are arranged on two opposite ends of the bottom bracket;
each of the two drive mechanisms includes a retractable push member;
each of the two linkages includes a first link pivotally connected with the push member of one of the two drive mechanisms and two second links pivotally connected with the first link;
the first link of each of the two linkages is pivotally connected with the frame;
the two connecting units are arranged on two opposite sides of the bottom bracket;
each of the two connecting units includes a transverse lever and two locking levers;
each of the two locking levers of each of the two connecting units has a first end pivotally connected with the transverse lever and a second end pivotally connected with the bottom bracket; and
each of the two locking levers of each of the two connecting units has a mediate portion pivotally connected with one of the two second links of one of the two linkages.

2. The motorized bed of claim 1, wherein the two drive mechanisms are operated synchronously.

3. The motorized bed of claim 1, wherein each of the two locking levers of each of the two connecting units is bent upward with an angle.
